(19) United States
(12) Patent Application Publication
(10) Pub. No.: US 2002/0135272 A1
(43) Pub. Date: Sep. 26, 2002

(54) Curved film electrostatic ultrasonic transducer

(76) Inventor: Minoru Toda, Lawrenceville, NJ (US)

Correspondence Address: EDWARD J. HOWARD, ESQ., Duane, Morris & Heckscher LLP, 100 College Road West, Suite 100, Princeton, NJ, 08540, US

(21) Appl. No.: 09/752,993

(22) Filed: Jan. 2, 2001

(51) Int. Cl. H02N 2/00

(52) U.S. Cl. 310/334

(57) ABSTRACT

An electrostatic air transducer apparatus comprises a curved piezoelectric film having a first outer surface and a second inner surface opposite the first outer surface. A first electrode material is disposed on the first outer surface of the film. A conductive back plate having a series of protrusions engages the inner surface of the film to form a series of air gaps therebetween.

### RELATED APPLICATIONS

This application is related to, commonly assigned patent application Ser. No. 09/566,612 entitled “CYLINDRICAL TRANSDUCER APPARATUS”, and and commonly assigned patent application Ser. No. 09/567,385 entitled MULTIPLE PIEZOELECTRIC TRANSDUCER ARRAY, the subject matter of which is incorporated herein by reference in their entireties.

### FIELD OF THE INVENTION

The present invention relates to the field of transducers, and more particularly to curved film electrostatic airborne transducers.

### BACKGROUND OF THE INVENTION

The structure of a conventional electrostatic transducer is composed of two primary parts. The first part is formed by an insulative thin film coated with a thin metallic layer on one side surface. The other part comprises a metallic back plate generally having a grooved surface structure in contact with the non-metallic side of the film. A DC voltage is applied between the surface metal layer and the back plate, and an AC voltage is superimposed onto it. The source of the DC voltage may be eliminated by using permanent charges embedded in the insulator surface which is electret.

The electrostatic force drives the film to vibrate at a given frequency. The force becomes larger for a smaller air space between the film and the back structure. The resonance frequency associated with the transducer is determined by the air volume in the backing structure, the mass and Young's modulus of film. The air volume plays an important role in determining the resonance frequency. This is because the very small air space is compressed or expanded by the film's vibration, and the generated force operates to counteract the displacement. Thus, the smaller the volume of air space, the larger the reaction force becomes. For such small volumes of air space, the reaction force is not negligible and may even be larger than the elastic restoring force of the film. Thus, the reaction force operates to determine the resonance frequency.

Prior art electrostatic transducers employ a flat membrane (i.e. film) material and flat back plate with the aforementioned fine surface structures. Such flat devices generate acoustic waves propagating mainly normal to the surface. Flat surface devices cannot cover continuously the periphery of a cylindrical body so as to generate an acoustic wave having substantially uniform intensity in the radial direction.

Another problem associated with conventional flat electrostatic transducers is the control of resonance frequency. In order to control the resonance frequency to within a predetermined value or range, the structure of the backplate must be designed to within extreme accuracy or tolerance ranges. In addition, in order to achieve high sensitivity transmitting and receiving modes associated with the transducer, the film thickness has to be very thin (e.g. within the range of 5-7 microns (um)). The manufacture of such thin films and high accuracy back structures is extremely difficult and poses significant problems in fabrication and mass production of electrostatic transducers. This results in expensive, low yield electrostatic transducers with inconsistent or non-uniform performance characteristics.

An electrostatic transducer and method of manufacture that overcomes the aforementioned problems is highly desired.

### SUMMARY OF THE INVENTION

The present invention is embodied in a cylindrical electrostatic transducer, or electrostatic curved film transducer, in which resonance frequency is controlled by back air space as accomplished in a regular flat transducer in one embodiment, and in addition, resonance frequency is controlled by back air space and by the curvature radius of the film in another embodiment, or is controlled primarily by the curvature radius.

An electrostatic air transducer apparatus comprises a curved piezoelectric film having a first outer surface and a second inner surface opposite the first outer surface. A first electrode material is disposed on the first outer surface of the film. A conductive back plate having a series of protrusions engages the inner surface of the film to form a series of air gaps therebetween. In a particular embodiment, the air gaps can be sized so as to negligibly influence resonance frequency associated with the curvature of the film.

The present invention is also embodied in a method of forming an electrostatic ultrasonic transducer comprising forming a layer of polymer film material into a cylindrical shape having an inner diameter D1; disposing a first electrode material on an outer surface of the cylindrically shaped polymer material; forming an elastically deformable conductive back plate having a series of protrusions on a first surface thereof into a cylindrical shape having an outer diameter D2 greater than the inner diameter D1; disposing the backplate within the inner diameter of said film material such that the protrusions engage the inner surface of the piezoelectric material forming a series of air gaps therebetween; and applying an electrical signal to the electrode material on the film material and the backplate to generate a signal at a predetermined resonance frequency.

### BRIEF DESCRIPTION OF THE DRAWINGS

FIG. 1A is an exemplary illustration of a polymer film material having a cylindrical shape for use in a curved electrostatic transducer according to an embodiment of the present invention.

FIG. 1B is an exemplary illustration of a thin metallic backplate having protrusions on a surface thereof.

FIG. 1C is an exemplary illustration of the metal backplate of FIG. 1(b) formed into a cylindrical shape.

FIG. 1D is an exemplary top view illustration of the curved electrostatic ultrasonic transducer according to an embodiment of the present invention.

FIG. 1E is an exemplary embodiment of an electret film having embedded surface charge for eliminating dc bias according to the present invention.

FIGS. 2(a) and 2(b) represent exemplary illustrations of different cross-sectional shapes associated with the protrusions on the surface of the backplate of an electrostatic transducer.

FIG. 3(a) is an exemplary illustration of a curved film electrostatic transducer in the shape of a partial cylinder according to an embodiment of the present invention. FIG. 3(b) is an exemplary illustration of a corrugated electrostatic ultrasonic transducer according to an embodiment of the present invention.

FIG. 4 is an exemplary illustration of a top view of a corrugated electrostatic transducer according to an embodiment of the present invention.

FIGS. 5(a) and 5(b) are exemplary illustrations of a corrugated electrostatic transducer having a common front electrode and separated back electrodes.

FIG. 5(c) illustrates an exemplary embodiment of an electret film which eliminates DC bias.

FIGS. 6(a) and 6(b) are exemplary illustrations of a corrugated electrostatic transducer having a common back electrode and separated front electrodes.

FIG. 7 is an exemplary illustration of a surface electrode pattern for an electrostatic transducer.

FIG. 8 is an exemplary illustration of a backplate having microscopic holes formed therein according to an aspect of the present invention.

FIG. 9 is an alternative embodiment of a backplate comprising a series of spaced apart, elongated structures having a single groove formed thereon and bonded onto a surface of a cylindrical holder.

FIG. 10 shows an alternative embodiment wherein a thin, perforated metal backplate is disposed on another backplate.

### DETAILED DESCRIPTION OF THE INVENTION

In order to radiate ultrasonic waves in air, a film material has to vibrate in the direction normal to the planer surface of the material. Therefore according to an aspect of the present invention a curved film material (forming a partial cylinder for example) or a cylindrical film material has to have a displacement in the radial direction. The radial motion of the cylindrical film has a resonance frequency at the which the displacement shows a maximum value. The resonance frequency is given by ·₁=(1/2πR)(Y/ρ)^{½}

where ρ is the density of the film material and Y represents Young's modulus of the film material. If the material is composed of two layers for example a metal layer and polymer layer, Y has to be the average of the two materials weighted by thickness.

This resonance is caused by the elastic expansion or shrinkage of the film along its curved direction. The elastic force due to strain in the film plane is converted to direction normal to the surface by the curved structure. The film mass and the elastic restoring force in the radial direction (i.e. spring) determines the resonance frequency of the transducer. Note that for electrostatic transducers, displacement of the thin film has a restoring force mainly from the back air space. The force becomes smaller for a larger air space. Hence according to an aspect of the present invention, the curved film resonance is not influenced by the back air space having a depth of more than about 0.2 millimeters (mm) in the case of 30 micron (um) film. Similarly for a film having a thickness of about 5 microns (um) the resonance of the curved film is not influenced by back air space if its depth is more than 1.3 mm. The above values are representative for a 40 (KHz) transducer using a curved polymer film. Note that the above are two examples for particular thickness of the film. It is understood that values may thus be different for different frequencies or different materials.

It is also understood that according to an aspect of the present invention, in order to provide radial vibration to a curved film, the necessary force required is much larger than that required to give flexural motion to a flat film. Thus, the force required to cause radial displacement of curved film is much greater (i.e. harder or stiffer) than the corresponding flat film for producing flexural notion. Accordingly, a back air space of less than 0.22 to 1.31 mm is typically used for conventional flat electrostatic transducers of 30 μm to 511 μm, wherein this air space controls the resonance frequency of the transducer. In contrast, the curved film electrostatic transducer of the present invention is operative to provide a resonance frequency which is mainly determined by the film curvature. This is because the curved film configuration is hard or stiffer than the corresponding flat film configuration.

According to an aspect of the present invention the back air space or air gap is relatively small and the high accuracy surface back structure of conventional back plates has been minimized or eliminated. Further according to an aspect of the present invention resonance is mainly controlled by the film curvature. Note that if the back air space is too large however, the vibration sensitivity from applied voltage or incoming acoustic pressure (for a receiver for example) is decreased because electrostatic force between the film electrode and back metallic plate is reduced.

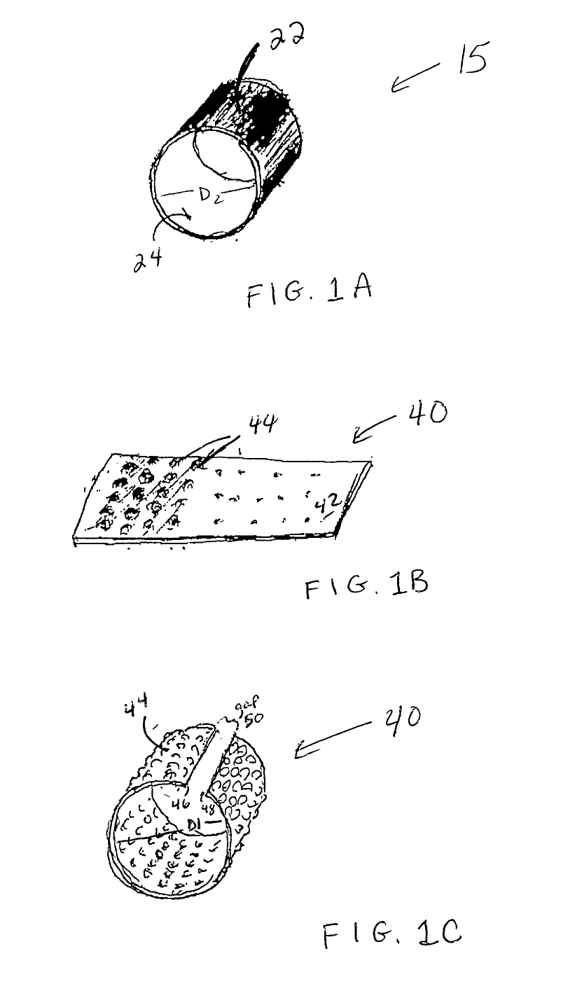

Referring now to FIGS. 1A-1D, there is shown the novel structure of a cylindrical electrostatic transducer 100 according to an aspect of the present invention. As shown in FIG. 1A, a polymer film 15 has a first outer surface 22 and a second inner surface 24 opposite the first surface. The first surface 22 of the polymer film is metalized by sputtering or vacuum deposition for example and is formed into a cylindrical shape as shown in FIG. 1A with the metallic side outwardly exposed. The ends of the polymer film material, each of which has a portion which is non-metalized, may overlap one another to enable the ends to be secured to one another. This may be accomplished via conventional means, such as adhesive bonding for example. Preferably, the cylindrical shape is formed by seaming the two ends of the rectangular film by ultrasonic welding, for example. The film material for the electrostatic transducer may be formed from polyester or polyimid, for example.

As shown in FIG. 1B, the electrostatic transducer includes backplate 40 comprising a thin metallic sheet with many small protrusions 44 (e.g. dimples) extending from surface 42 in a predetermined pattern. The backplate with protrusions may be formed by a press machine, for example. As shown in FIG. 1C, the metal backplate is formed into a cylindrical shape having a diameter D1 (in unrestrained form) somewhat larger than that of polymer film diameter D2, with the ends 46, 48 separated from one another via gap 50. The cylindrical metal is sufficiently thin that it can be elastically deformed to decrease the diameter D1 below D2 for inserting the backplate into the interior of the polymer cylinder 15. The diameter D1 of metallic cylinder backplate 40 is kept by polymer cylinder 15, wherein upon insertion of backplate 40 within polymer film structure 15 the gap 50 becomes almost zero. Because the gap 50 is virtually zero, this permits the transducer to vibrate in substantially uniform manner. The combined structure shown in FIG. 1D represents the cylindrical electrostatic transducer 100 of the present invention, and may be used in a manner commensurate with that of a conventional flat electrostatic transducer, without the high tolerance requirements and thin film requirements of such prior art flat electrostatic transducer designs. A dc voltage is applied to bias the transducer and ac field is superposed thereon, as shown in FIG. 1D. The height of the protrusions or dimples is chosen as indicated previously (e.g. 0.2- 1.3 mm for 30- 50 μm polymer film at 40 KHz) so as to appropriately size the back air gaps 51. In the case shown in FIG. 1E where an electret film 15′ having embedded surface charge is used, the dc bias can be eliminated. Note that to turn an insulative film to electret, for example, polyester, the inner surface of the film may be exposed to a high energy electron beam and electrons are implanted deeply into the film, for example. Note that the cylindrical structure of the electrostatic transducer may be sized appropriately so as to be applied to a pen position sensor system, for example, wherein the inner diameter D1 of the structure is sized to accommodate a pen or other writing instrument. It is contemplated that the inner diameter D1 of the backplate may be sized so as to frictionally engage the pen (for securing thereto), or that the a casing may be applied to the transducer structure accommodating the pen via diameter D1 to attach the pen to the transducer for securing thereto.

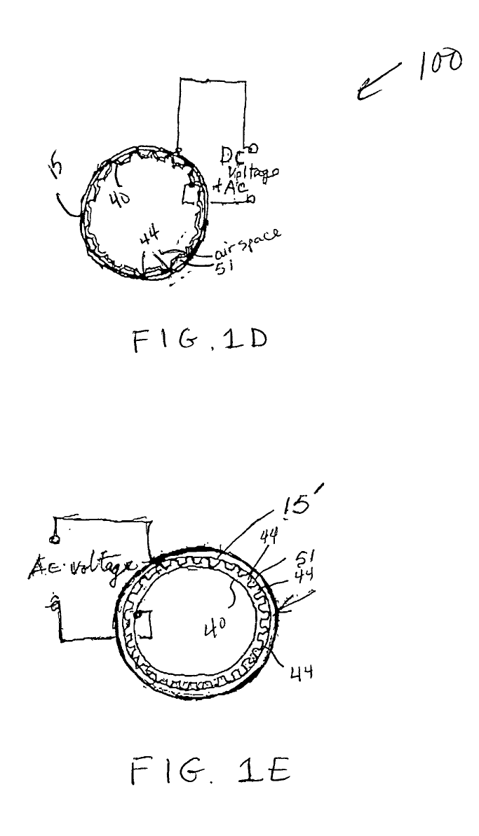

The metal backplate 40 may be machined from thick metallic tubing to form grooved surface 42. The cross sectional shape of the protrusions 44 (or grooves) may be rectangular or triangular, for example. Such configurations are illustrated in FIG. 2a and FIG. 2b respectively. As an alternative to the method discussed above, the metallic tubing having the grooved surface structure with protruding ridges 44 and corresponding gaps 51 is formed first (see FIG. 2C and FIG. 2D) and the polymer film layer 15 is wrapped around the backplate. The ends of the film are then bonded together to form a cylinder. Note that the polymer film should be appropriately sized and fit to the metallic backplate surface structure since the back air space is an important feature. If it is too thin, the resonance frequency becomes higher and if it is too thick, sensitivity is lowered.

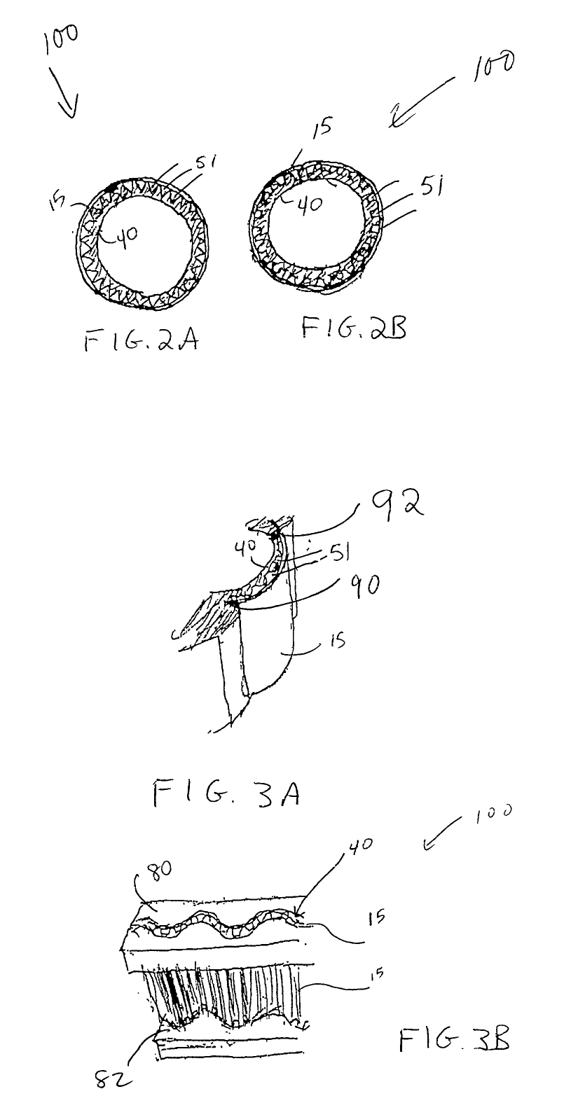

As shown in FIG. 3A, an electrostatic transducer may be in the form of a curved film 15 that can be a partial cylinder having its two ends clamped at predetermined positions 90, 92 for example using a conventional clamp structure. Alternatively, the electrostatic transducer may have a corrugated shape or structure as shown in FIG. 3B. The metallic backplate structure should have space or depth as previously specified. Note that the back plate 40 may be more economically produced by the aforementioned protrusions (or dimples) formed by a press machine or machined onto the metallic plate. In the case of a corrugated electrostatic transducer, the curved shape is supported by structures 80 at the top and 82 at the bottom which serve to hold and support the film. Such corrugations are disclosed in copending, commonly assigned patent application Ser. No. 09/567,385, the subject matter thereof incorporated herein by reference.

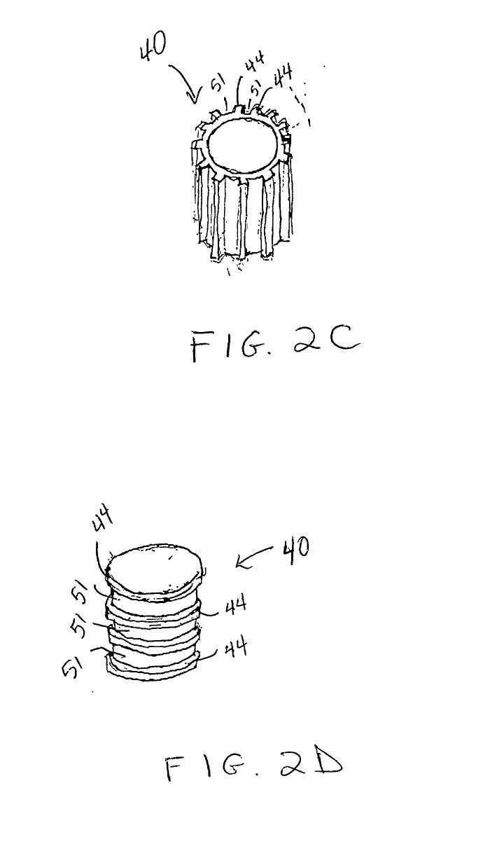

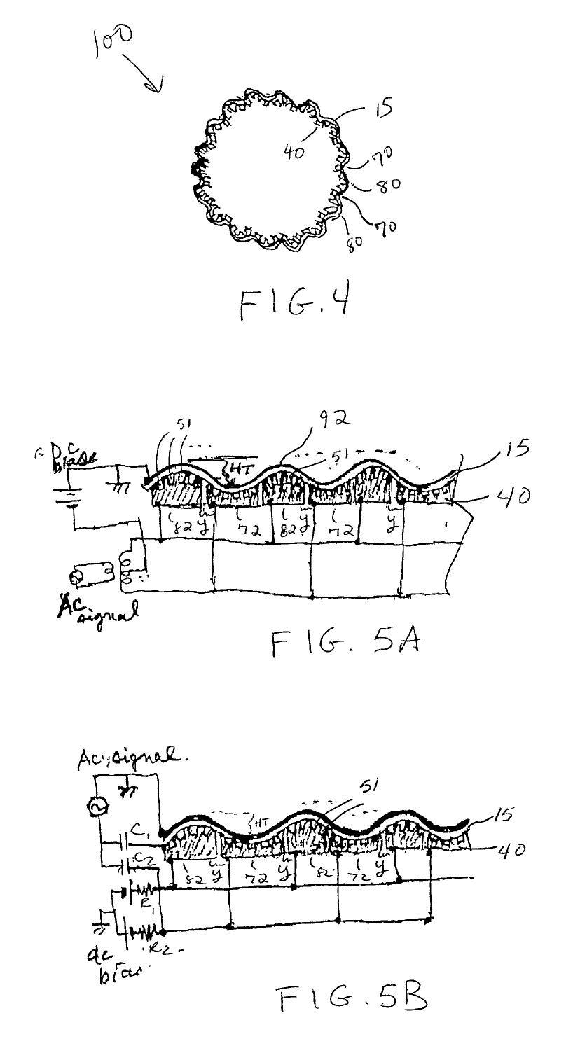

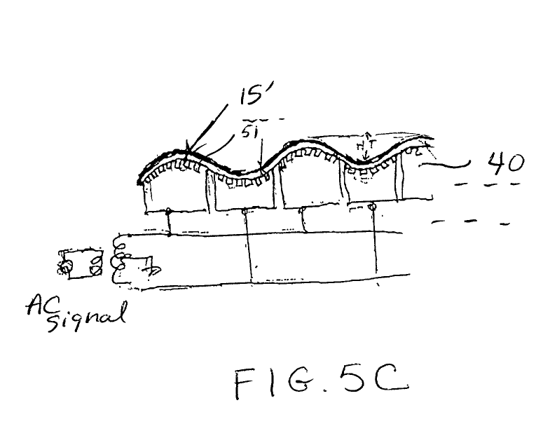

As is understood, the electrostatic ultrasonic corrugation devices shown in FIGS. 4, 5 and 6 have concave regions 70 and convex regions 80, and vibrations in one type of region has the opposite phase compared with the other type region. The radiated waves from these two regions are in opposite phase relative to each other, however, the corrugation height HT (see FIG. 5A) is preferably chosen to about half of the wavelength in air, so that propagation path differences cancel the opposite phase effect. The vibration of polymer film is excited by an electrostatic force. The concave and convex regions are excited by forces having opposite phase relative to each other. Therefore, the electrodes for the concave regions and convex regions are separated. For this purpose, two types of structures are possible. One is a common front electrode 92 and separated back electrodes 72, 82, as shown in FIGS. 5A and 5B. The structure as shown in FIG. 5C eliminates DC bias using electret film 15′. As illustrated, the back electrodes 72, 82 are separated by a given distance typically 0.5 mm. Another embodiment is the common back electrode 74 and separated front electrodes 94, 96, as shown in FIGS. 6A and 6B. Here, the front electrodes are separated from one another by a predetermined distance typically 0.5 mm. For these embodiments, two types of operational modes exist. The first mode, shown in FIGS. 5A and 6A, is depicted by a DC biased field which is in the same direction across the transducer and an AC signal field which has an opposite direction (i.e. opposite phase) for the two regions (i.e. concave and convex regions). The second mode, shown in FIGS. 5B and 6B, is depicted by AC signal fields which are in the same direction for these two type of regions and a DC biased field which is in the opposite direction for these regions.

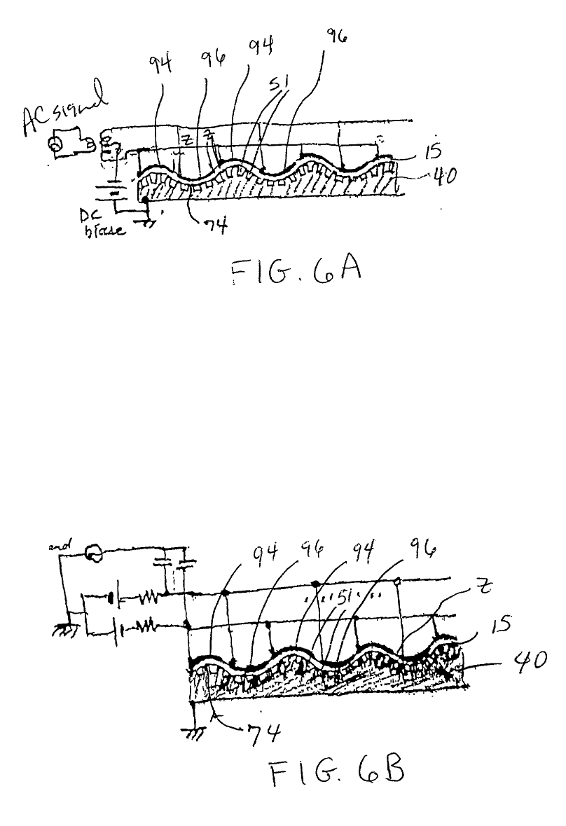

FIGS. 6A and 6B show that surface electrodes are alternately connected to different voltage sources. In still another alternative embodiment, FIG. 7 shows a surface electrode pattern which eliminates many connection wires and requires just two wire connections to yield the same function as the separated electrodes in FIG. 6A and 6B. The structure shown in FIG. 7 comprises electrode material 76 and 98 deposited on a polymer film 15, where the electrodes are separated from one another by a non-conductive region 99 on the film 15.

The surface grooved back electrode structure can be produced from machined metal block as shown in FIGS. 1B, 1C, 2A, 2C and 2D. Alternatively a molded plastic having a coating of thin metallic electrodes on the grooved surface may also be used. Another alternative is the use of a thin metal sheet formed with periodic grooves by pressing and formed to a corrugated shape. This is then further formed to a cylinder to provide a cylindrical corrugation device.

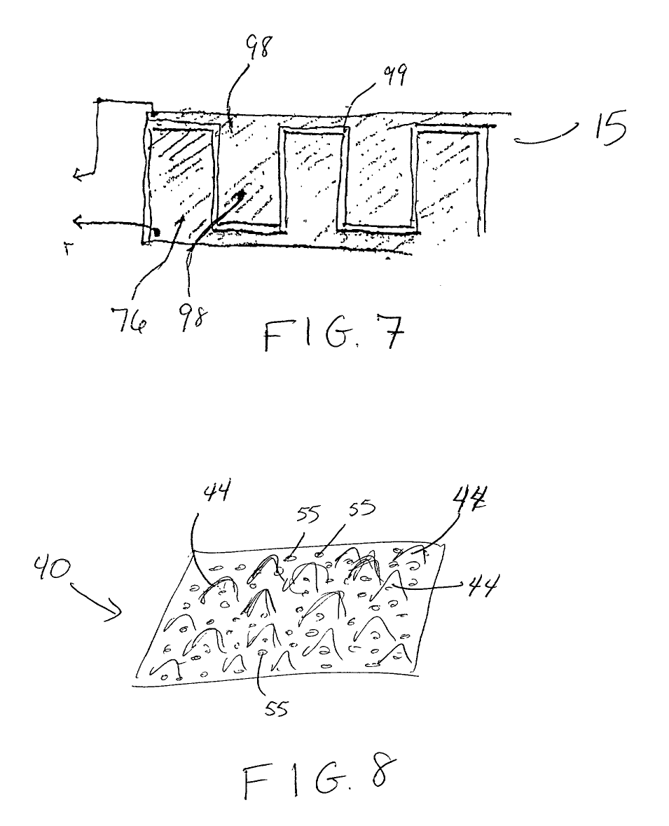

In order to enhance the sensitivity of the transducer as both a transmitter and/or a receiver, the depth of back air space is made to much thinner degree than the above specified value (sensitivity increases because electrostatic force is increased due to the smaller separation between two conductive plates). However, the resonance frequency is increased due to trapped air effect. In order to overcome this problem, many tiny holes 55 are formed on the thin backing plate 40 as shown in FIG. 8. These very fine, microscopic holes with a high density can be made by photo lithography, for example. The height of the dimple formed on the backplate surface is made to a much smaller size than that described in the previous embodiments, for example. The compressed or expanded air in back space may easily pass through the holes 55 so that the back air space does not influence the resonance frequency. FIG. 5D shows a top view of an exemplary corrugated omni directional transducer having the structure described above.

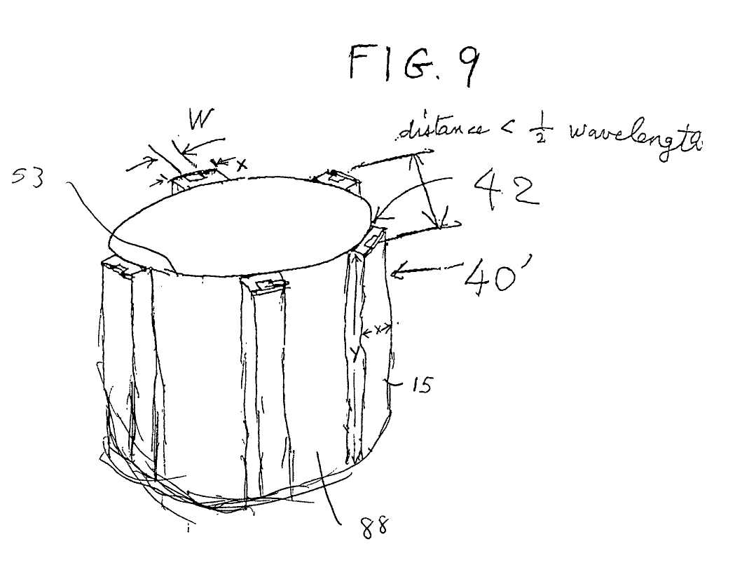

As shown in FIG. 9, depending on the process, it is easier to produce a plurality of an electrostatic transducer having the illustrated configuration. Discontinuous regions 88 exists elongated structures 40′, each elongated structure having one groove or gap 51 of width ‘w’ formed onto a substrate having a substantially flat surface 42 bonded onto a surface of a cylindrical holder 53 in parallel direction to the axis of the cylinder. A substantially flat polymer film having electrode material deposited on the front and back surfaces thereof is disposed across the width ‘x’ and length ‘y’ of each rod and secured thereto in conventional fashion, so as to form between each of the elongated rods and corresponding film materials as shown in FIG. 9. In an illustrative embodiment, the ratio of w/x is between 1/3 and 4/5. Because the width w of each element 40′ is much smaller than the wavelength, an ultrasonic wave from this one element diverges into 180 degree horizontal direction.

Although the acoustic pressure from one element is weaker than those devices having substantially the entire surface covered by many grooves and continuous films as shown in FIG. 1D, 1E, 2A and 2B, this may be useful for certain applications, for example, for very short distances. In this case, the ultrasonic waves from different elements interfere and acoustic pressure in certain directions is canceled and the beam directivity shows a non-uniform pattern. In order to reduce the interference effect, the straight distance between elements has to be less than one half of the wavelength. This condition can be achieved when two elements are bonded on 180 degree opposite positions, when the diameter D is less than the half of wavelength. When three elements 40′ are bonded in 120 degree separation, 2D/\sqrt{3} has to be less than half of the wavelength. When N elements are bonded with 2πn/N degree separation, D sin (π/N) has to be less than the one half wavelength.

The structures described above have illustrated a curved film structure of which resonance is mainly determined by the curvature of the film and back air space less influences the resonance frequency. However, if the back space is made to a smaller size than the above specified values, i.e., 0.2 mm for 30 μm film and 3 mm for 5 μm film, the structure still functions as a good transducer, however, the resonance is influenced (i.e. becomes higher for smaller space) by the back space and thus requires more accurate control of back space. This in turn requires the height of the dimples 42 to be more accurately controlled. This type of operation is possible and this operational mode becomes closer to that of a conventional electrostatic transducer. The primary difference is that the proposed structure is curved or cylindrical while conventional devices are substantially flat.

The air depth which critically influences resonance is given by the following equation. The Effective spring constant K (per unit area) of curved film is given by

K_{mb}=Yh/R²=4π²hƒ₀²ρ ƒ₀ is given by eq.(1)

where p is the density of film material 15, R is the curvature radius which determines resonance frequency through eq. (1), h is the thickness of the polymer film, and Y is Young's modulus of the polymer, respectively. The effect of metal to Y and ρ is negligible because it is very thin.

While the above provides the spring constant for the film, the effective spring constant of back air space (per unit area) is given by

Kₐᵢᵣ=ρₐVₐ²/d

where ρₐ is the density of air, Vₐ is the sound velocity of air (344 m/sec), and d is the depth of back air space. In order for back air space to have a negligible effect or influence on resonance of an electrostatic transducer, a condition of K_{mb}>>Kₐᵢᵣ is needed.

The resonance frequency influenced by back-air effect is expressed by

ƒ₀=(1/2π)\sqrt{(Kₐᵢᵣ+K_{mb})/ρ}

Because of the square root factor, if Kₐᵢᵣ/K_{mb} is 0.2, ƒ₀ in eq. (1) increases by 10% due to the effect of back air space.

Table 1 shown below provides different frequencies and different film thickness where the back air space yields 10% increase of the resonance frequency ƒ₀ (assuming the metal layer is thin therefore neglible)

TABLE 1

| (1)f₀ = 40 KHz | | | | |
|---|---|---|---|---|
| h = 30, | 20, | 10, | 5 | μm |
| d = 0.22, | 0.32, | 0.65, | 1.3 | mm |
| (2)f₀ = 80 KHz | | | | |
| h = 30, | 20, | 10, | 5 | μm |
| d = 0.54, | 0.081, | 0.162, | 0.32 | mm |
| (3)f₀ = 120 KHz | | | | |
| h = 30, | 20, | 10, | 5 | μm |
| d = 0.24, | 0.036, | 0.072, | 0.14 | mm |

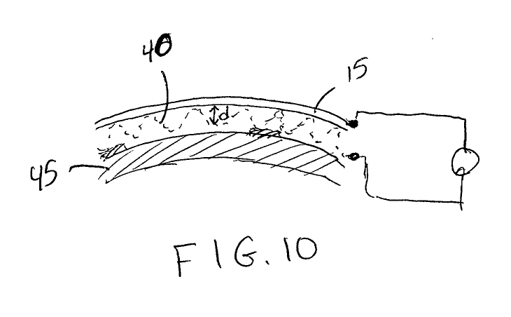

If the thin metal backplate 40 is perforated, the depth d of back air space does not influence resonance even it is very much thinner than the above d value. Attaching another back plate 45 influences resonance if it is less than d, as shown in FIG. 10. Such structures can be applied to all other curved electrostatic ultrasonic transducers.

While the foregoing invention has been described with reference to the above embodiments, various modifications and changes can be made without departing from the spirit of the invention. Accordingly, all such modifications and changes are considered to be within the scope of the appended claims.

What is claimed is:

1. An electrostatic air transducer apparatus comprising:
a curved piezoelectric film having a first outer surface and a second inner surface opposite said first outer surface;
a first electrode material disposed on said first outer surface of said film; and
a curved conductive back plate having a series of protrusions engaging said inner surface of said film forming a series of air gaps therebetween.

2. The apparatus according to claim 1, wherein said conductive backplate is curved in a cylindrical shape, said backplate having a first end and a second end separated by a predetermined gap.

3. The apparatus according to claim 1, wherein said piezoelectric film has an effective spring constant greater than an effective spring constant associated with said air gaps.

4. The apparatus according to claim 1, wherein said, conductive backplate further includes a plurality of microscopic holes formed therein.

5. The apparatus according to claim 1, wherein said film material is corrugated.

6. The apparatus according to claim 5, wherein the corrugated film material comprises a series of corrugations each having a height of about one half wavelength.

7. The apparatus according to claim 1, wherein said film has a thickness of about 30 microns, said resonance frequency is about 40 KHz, and said gap is greater than 0.2 millimeters.

8. The apparatus according to claim 1, wherein said film material is a polymer film.

9. The apparatus according to claim 1, wherein said air gaps are sized so as to mitigate perturbations to a predetermined resonance frequency associated with the curvature of said film.

10. A cylindrical electrostatic transducer comprising:
a cylindrically shaped layer of piezoelectric material, a first outer surface and a second inner surface opposite said first outer surface, said cylindrically shaped material having an inner diameter D1;
a first electrode material disposed on said first outer surface of said cylindrically shaped material; and
a cylindrically shaped, elastically deformable conductive back plate having a series of protrusions on a first surface thereof, said deformable conductive back plate having an inner diameter D2 greater than D1 such than when said deformable back plate is deformably disposed within an interior of said cylindrically shaped layer of piezoelectric material, said protrusions engage said inner surface of said piezoelectric material forming a series of air gaps therebetween.

11. The transducer according to claim 10, wherein said piezoelectric film has an effective spring constant greater than an effective spring constant associated with said air gaps.

12. The transducer according to claim 10, wherein said backplate further includes a plurality of microscopic holes formed therein.

13. The transducer according to claim 10, further comprising a second, monolithic backplate layer disposed beneath said backplate and coupled thereto, wherein the total thickness associated with said first and second backplate layers is less than said gap size.

14. The transducer according to claim 10, wherein said air gaps are sized so as to negligibly affect a predetermined resonance frequency associated with the curvature of said piezoelectric material and corresponding to radial vibration of said piezoelectric material.

15. A method of forming an electrostatic ultrasonic transducer comprising:
forming a layer of polymer film material into a cylindrical shape having an inner diameter D1;
disposing a first electrode material on an outer surface of said cylindrically shaped polymer material;
forming an elastically deformable conductive back plate having a series of protrusions on a first surface thereof into a cylindrical shape having having an outer diameter D2 greater than said inner diameter D1;
disposing said backplate within the inner diameter of said film material such that said protrusions engage said inner surface of said piezoelectric material forming a series of air gaps therebetween; and
applying an electrical signal to said electrode material on said film material and said backplate to generate a signal at a predetermined resonance frequency.

16. The method according to claim 15, wherein said elastically deformable conductive backplate has a predetermined gap extending along an axis thereof so as to facilitate deformation.

17. The method according to claim 15, further comprising forming microscopic holes in said backplate.

18. The method according to claim 15, wherein the step of applying an electrical signal comprises applying a DC signal and superimposing an AC signal thereon.

19. The method according to claim 15, further comprising the step of forming corrugations said cylindrical film material so as to provide concave and convex regions therein.

20. The method according to claim 19, further comprising the step of providing on said film material a common front electrode and separated back electrodes.

21. The method according to claim 19, further comprising the step of providing on said film material a common back electrode and separated front electrodes.

22. The method according to claim 15, further comprising the step of sizing said air gaps so as to mitigate perturbations to the predetermined resonance frequency associated with the curvature of said piezoelectric material and corresponding to radial vibration of said material.
